(19) United States
(12) Patent Application Publication
(10) Pub. No.: US 2025/0190905 A1
(43) Pub. Date: Jun. 12, 2025

(54) SUPPLY CHAIN NETWORK CREATION APPARATUS, SUPPLY CHAIN NETWORK CREATION METHOD AND PROGRAM

(71) Applicant: Hitachi, Ltd., Tokyo (JP)

(72) Inventors: Keiichi BAMOTO, Tokyo (JP); Teppei INOUE, Tokyo (JP); Tazu NOMOTO, Tokyo (JP); Tomoko UEHARA, Tokyo (JP)

(21) Appl. No.: 18/885,042

(22) Filed: Sep. 13, 2024

(30) Foreign Application Priority Data
Dec. 12, 2023 (JP) 2023-209640

(51) Int. Cl. G06Q 10/0631; G06Q 10/0875

(52) U.S. Cl. CPC G06Q 10/06315; G06Q 10/0875

(57) ABSTRACT

Provided are a supply chain network creation apparatus, a supply chain network creation method, and a program that, when creating a supply chain network for a target item, can extract companies further upstream and is less likely to include companies that are not related to the item. A supply chain network creation apparatus 100, comprising a BOM creation unit 122 that creates a BOM (bill of materials) based on a transaction history 132 including information on an order-placing company, an order-accepting company, and items traded between the order-placing company and the order-accepting company, and a supply chain network creation unit 121 that creates a supply chain network representing a transaction relationship between the order-placing company and the order-accepting company based on the BOM.

### CROSS REFERENCE TO RELATED APPLICATIONS

This application claims priority based on Japanese patent application No. 2023-209640, filed on Dec. 12, 2023, the entire contents of which are incorporated herein by reference.

### TECHNICAL FIELD

The present invention generally relates to a supply chain network creation apparatus, a supply chain network creation method, and a program, and particularly relates to a supply chain network creation apparatus and the like that can be suitably used to hierarchically extract a supply chain network between an order-placing company and an order-accepting company.

### BACKGROUND ART

Recently, for example, in the manufacturing and distribution industry, there are increasing risks that threaten stable production and business continuity, such as shortages of semiconductors and other materials, and soaring raw material and energy prices, caused by disasters, financial crises, terrorism, and pandemics. Moreover, with the global expansion of business, the proportion of companies exposed to these risks is increasing as suppliers, manufacturers, wholesalers, logistics companies, and distributors that make up the supply chain (SC) related to one product are dispersed around the world. In response to this situation, attention is being paid to strengthening the supply chain. Specifically, it is necessary to understand the companies that make up one's own supply chain, understand in advance the risks that may affect production activities, and take measures in advance, as well as to have a system that can quickly grasp the situation and take immediate measures when an incident occurs. Nevertheless, although companies are aware of the suppliers (for the sake of convenience, hereinafter referred to as “Tier 1”) that they have direct transactions with and their items, it is difficult for companies to understand the companies and items upstream of Tier 1 because information on suppliers (for the sake of convenience, hereinafter referred to as “Tier 2”) involved in the production by each Tier 1 is confidential information. Currently, it is necessary to either conduct a labor-intensive, human-wave investigation or estimate and identify the foregoing information in some way.

PTL 1 describes an information processing system. This information processing system includes a supply chain network acquisition unit that acquires a supply chain network in which a plurality of nodes corresponding to a plurality of companies, to which attributes related to the companies including the industrial classification of the companies are assigned, are connected by a plurality of links indicating the business relationships that associate product providing companies and product receiving companies. This information processing system also includes a vector expression calculation unit that calculates a plurality of vector expressions that indicate the feature quantities of the plurality of nodes corresponding to each of the plurality of nodes by applying a graph embedding technique to the supply chain network. As an application example of this information processing system, when the degree of association between the vector expression of a node indicating a semiconductor manufacturing company and the vector expression of a node indicating a manufacturing equipment manufacturer is equal to or greater than a given threshold, this information processing system can determine that the link connecting the node indicating the semiconductor manufacturing company and the node indicating the manufacturing equipment manufacturer is an essential link related to the business. Meanwhile, when the degree of association between the vector expression of a node indicating a semiconductor manufacturing company and the vector expression of a node indicating a food-related company is less than a given threshold, this information processing system can determine that the link connecting the node indicating the semiconductor manufacturing company and the node indicating the food-related company is an inessential link that is not related to the business.

### CITATION LIST

### Non-Patent Literature

[PTL 1] Japanese Unexamined Patent Application Publication No. 2023-50018

### SUMMARY OF THE INVENTION

### Problems to be Solved by the Invention

With conventional technologies, a supply chain network is expressed in a form in which nodes representing companies and links that associate product order-placing companies and product order-accepting companies are connected. Here, the degree of association is calculated based on attributes such as the industrial classification of the companies, and essential links related to the business are identified. Nevertheless, for example, in the manufacturing industry, products are often produced using items with different middle classifications in the industrial classification. For example, computer parts are related to multiple middle classifications such as plastics, rubber, steel, non-ferrous metals, and semiconductors. Although a company that produces these components belongs to the manufacturing industry in the large classification, when focusing on the degree of association of the large classifications, there is a possibility that the components related to the production of personal computers and the companies that handle them cannot be sufficiently narrowed down. In other words, for example, even if it is desirable to create a supply chain network for personal computers, companies other than the companies that handle the components of personal computers may be included in the supply chain network.

An object of the present invention is to provide a supply chain network creation apparatus, a supply chain network creation method, and a program that, when creating a supply chain network for a target item, can extract companies further upstream and is less likely to include companies that are not related to the item.

### Means to Solve the Problems

In order to achieve the foregoing object, the present invention is a supply chain network creation apparatus, comprising a bill of materials creation unit that creates a bill of materials based on a transaction history including information on an order-placing company, an order-accepting company, and items traded between the order-placing company and the order-accepting company, and a supply chain network creation unit that creates a supply chain network representing a transaction relationship between the order-placing company and the order-accepting company based on the bill of materials. In the foregoing case, it is possible to provide a supply chain network creation apparatus that can extract companies further upstream when creating a supply chain network for a target item, and that is less likely to include companies that are not related to this item.

Here, for example, the bill of materials creation unit creates the bill of materials for items procured commonly by the order-placing company from the order-accepting company based on the transaction history. In the foregoing case, it is possible to narrow down the companies related to the target item.

Moreover, for example, the supply chain network creation apparatus further comprises an item categorization unit that, based on an item classification table in which items are defined in two or more classification tiers, estimates tiers in the item classification table and classifications for each tier for items being traded from the transaction history, wherein the bill of materials creation unit creates the bill of materials based on classification items estimated by the item categorization unit. In the foregoing case, even if the item is called different names by different companies, it can be identified as being the same item.

In addition, for example, the item categorization unit determines a similarity between an item name of a first tier, which is a most detailed tier in the item classification table, and an item being traded, and classifies the item being traded under an item name of a second tier, which contains a largest number of similar items of the first tier and which is one level above the first tier. In the foregoing case, categorization can be performed more accurately.

Furthermore, for example, the item categorization unit, when there is no item that is similar to the first tier, classifies the item being traded by successively increasing the tier. In the foregoing case, the categorization result can be obtained more easily. In addition, for example, the supply chain network creation unit creates supply chain network information representing a relationship among the order-placing company, the order-accepting company, and the items handled by the order-accepting company based on the transaction history, and creates the supply chain network based on the supply chain network information. In the foregoing case, a rough supply chain network can be created.

Moreover, for example, the supply chain network creation unit creates the supply chain network information in addition to transaction relationship information including buyer companies and supplier companies. In the foregoing case, it is possible to suppress companies that should be included in the supply chain network from being excluded. In addition, for example, the supply chain network creation unit creates the supply chain network by deleting companies not included in the bill of materials. In the foregoing case, it is possible to exclude companies not related to the target item and narrow down the companies that are related to the target item.

Furthermore, for example, the supply chain network creation unit creates the supply chain network by deleting companies not included in the bill of materials for each tier when considering the tier relationship of the order-placing company and the order-accepting company. In the foregoing case, the resources used to create the supply chain network can be reduced.

Moreover, for example, the supply chain network creation unit creates display information representing a supply chain network in which the order-placing company is a parent node, the order-accepting company is a child node, and the transaction relationship is an arc. In the foregoing case, a supply chain network that is visually easy to understand can be displayed.

In addition, for example, the supply chain network creation unit creates the display information by changing a method of displaying at least one of either the arc or the node depending on at least one of either accuracy of the transaction relationship or newness at a time when the transaction history was created. In the foregoing case, the reliability of the supply chain network can be comprehended visually.

Furthermore, for example, the bill of materials creation unit creates a character string inquiring about materials to be used in producing the item, and creates the bill of materials using generative AI or a search engine based on the character string. In the foregoing case, the bill of materials can be created more easily.

Moreover, the present invention is also a supply chain network creation method, wherein a processor executes a program recorded in a memory to create a bill of materials based on a transaction history including information on an order-placing company, an order-accepting company, and items traded between the order-placing company and the order-accepting company, and create a supply chain network representing a transaction relationship between the order-placing company and the order-accepting company based on the bill of materials. In the foregoing case, it is possible to provide a supply chain network creation method that can extract companies further upstream when creating a supply chain network for a target item, and that is less likely to include companies that are not related to this item.

In addition, the present invention is also a program that causes a computer to realize a function of creating a bill of materials based on a transaction history including information on an order-placing company, an order-accepting company, and items traded between the order-placing company and the order-accepting company, and a function of creating a supply chain network representing a transaction relationship between the order-placing company and the order-accepting company based on the bill of materials. In the foregoing case, a function that can extract companies further upstream when creating a supply chain network for a target item, and that is less likely to include companies that are not related to this item can be realized with a computer.

### Advantageous Effects of the Invention

According to the present invention, it is possible to provide a supply chain network creation apparatus, a supply chain network creation method, and a program that, when creating a supply chain network for components configuring a product, can extract companies further upstream and is less likely to include companies that are not related to the product.

### BRIEF DESCRIPTION OF DRAWINGS

FIG. 1 is a block diagram showing the overall configuration of the information processing system according to this embodiment.

FIG. 2 is a flowchart showing the operational flow when the supply chain network creation unit creates a supply chain network.

FIG. 3 is a diagram showing an example of the company information.

FIG. 4 is a diagram showing an example of the transaction history.

FIG. 5 is a diagram showing an example of the transaction relationship information.

FIG. 6 is a diagram showing an example of the SC network information.

FIG. 7 is a diagram showing an example of the company item information.

FIG. 8 is a diagram showing an example of the BOM information.

FIG. 9 is a flowchart showing the operational flow when the BOM creation unit creates a BOM.

FIG. 10 is a diagram showing an example of the product code information.

FIG. 11 is a diagram showing an example of the display screen of the supply chain network.

FIG. 12 is a flowchart showing the method of creating a BOM in the second embodiment.

FIG. 13 is a diagram showing a hardware configuration example of the supply chain network creation apparatus in this embodiment.

### DESCRIPTION OF EMBODIMENTS

An embodiment of the present invention is now explained in detail with reference to the appended drawings. Here, the present invention is explained based on the first embodiment and the second embodiment.

### First Embodiment

### <Overall Explanation of Information Processing System 1>

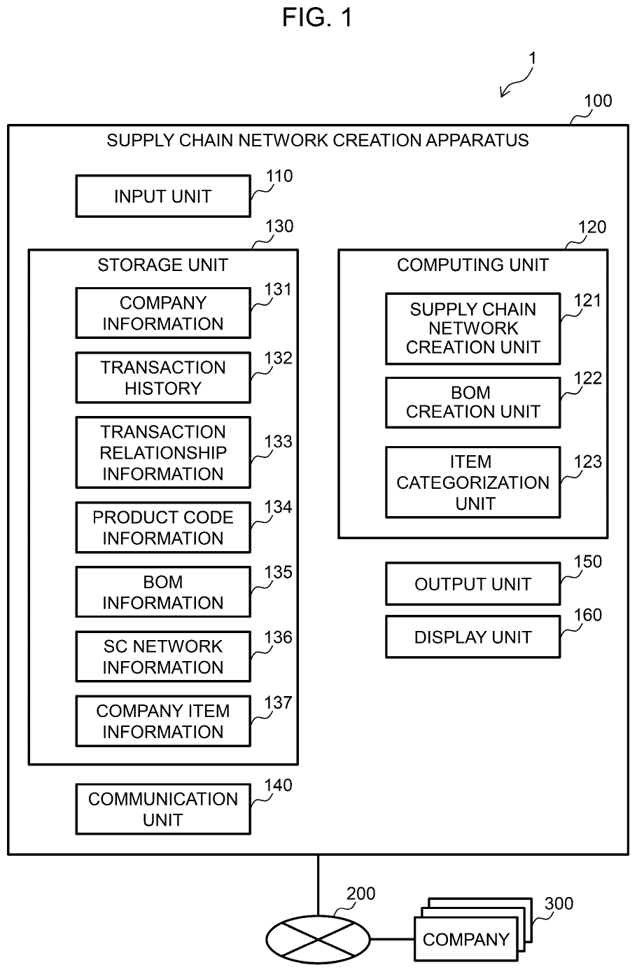

FIG. 1 is a block diagram showing the overall configuration of the information processing system 1 according to this embodiment.

In the information processing system 1, a supply chain network creation apparatus 100 that creates a supply chain and an external company information management device 300 that manages information concerning companies are connected via a communication means 200.

The supply chain network creation apparatus 100 comprises an input unit 110, a computing unit 120, a storage unit 130, a communication unit 140, an output unit 150 and a display unit 160.

The input unit 110 receives inputs from a user. The input unit 110 is, for example, an input device. The input device may be a keyboard, a touch pad, a mouse, a track ball or the like.

The computing unit 120 performs processing of creating a supply chain network. The computing unit 120 is, for example, a processor such as a CPU (Central Processing Unit). The computing unit 120 creates a supply chain network by executing programs such as an OS (basic software) and application software (applied software).

The computing unit 120 comprises a supply chain network creation unit 121, a BOM (Bill Of Materials) creation unit 122, and an item categorization unit 123. The BOM creation unit 122 is an example of a bill of materials creation unit, and creates a BOM based on a transaction history 132 including information on an order-placing company, an order-accepting company, and items traded between the order-placing company and the order-accepting company. A BOM (Bill Of Materials) is a diagram or a table that records information on components and units that configure a product. Here, the BOM creation unit 122 creates a BOM based on the items procured commonly by the order-placing company from the order-accepting company based on the transaction history 132. The supply chain network creation unit 121 creates a supply chain network representing a transaction relationship between the order-placing company and the order-accepting company based on the BOM. The item categorization unit 123 estimates tiers in the product code information 134 and classifications for each tier for items being traded from the transaction history 132 based on the product code information 134.

The storage unit 130 stores programs and data that run on the computing unit 120. The storage unit 130 is, for example, a ROM (Read Only Memory) that stores a BIOS (Basic Input Output System) or a RAM that is used as a main storage device. Moreover, the storage unit 130 is, for example, a storage such as an HDD (Hard Disk Drive) or an SSD (Solid State Drive).

The storage unit 130 stores company information 131, which is information concerning companies, a transaction history 132, which is information concerning the transaction history between companies, transaction relationship information 133, which is information concerning the transaction relationship between companies, product code information 134, which is a product classification code, BOM information 135, which is information concerning the BOM (bill of materials), SC (Supply Chain) network information 136, which is information concerning the supply chain, and company item information 137, which is information concerning the items of products and components handled by the company. Details concerning the foregoing information will be described later.

The communication unit 140 communicates with the outside. The communication unit 140 is, for example, a communication interface.

The output unit 150 outputs information of the supply chain network created by the computing unit 120. The output unit 150 is, for example, one function of the processor. The display unit 160 displays the supply chain network created by the computing unit 120. The display unit 160 is, for example, a display, and is specifically a liquid crystal display or an organic EL (Electro Luminescent) display. Note that the input unit 110 and the display unit 160 may be a touch panel that comprises both functions.

The communication means 200 is used for information communication between the supply chain network creation apparatus 100 and an external company information management device 300 and is, for example, the Internet, a LAN (Local Area Network), or a WAN (Wide Area Network). The communication line used for information communication may be wired or wireless, or a combination of the two. Moreover, the supply chain network creation apparatus 100 and the external company information management device 300 may be connected via a plurality of networks or communication lines using a relay device such as a gateway device or a router.

The external company information management device 300 collects from the companies and stores the company information 131, the transaction history 132, and the transaction relationship information 133. Subsequently, in response to a request from the supply chain network creation apparatus 100, the external company information management device 300 provides the foregoing information via the communication means 200.

### <Overall Explanation of Supply Chain Network Creation>

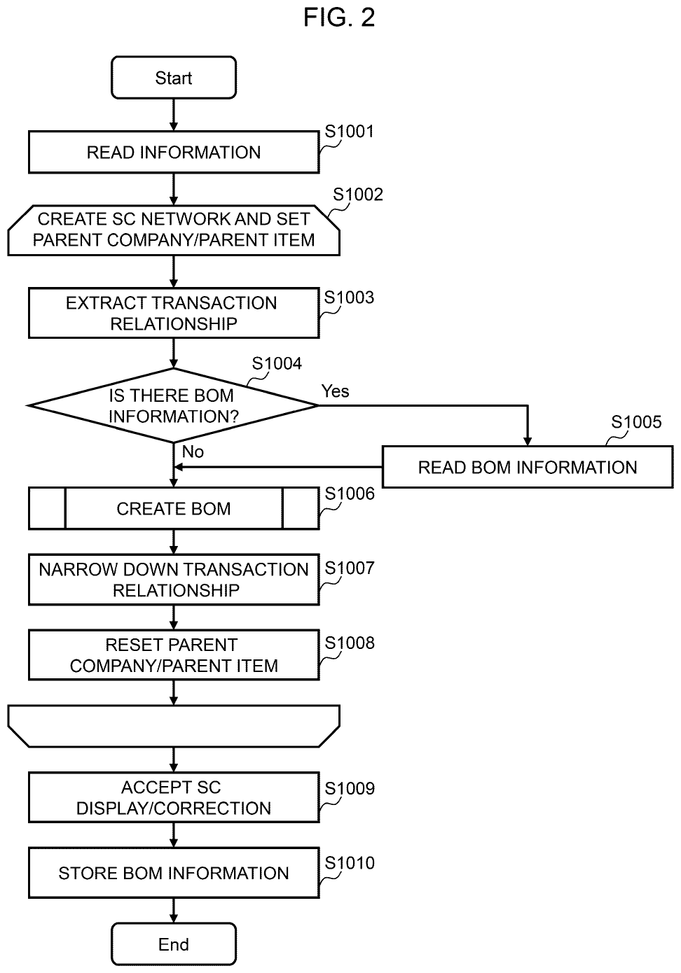

FIG. 2 is a flowchart showing the operational flow when the supply chain network creation unit 21 creates a supply chain network.

The supply chain network creation processing performed by the supply chain network creation unit 121 of this embodiment is run when a processing command from the input unit 110 is detected. The processing command includes the company name and item for which the supply chain network is to be created. When the supply chain network creation unit 121 receives a processing command, the supply chain network creation unit 121 reads information related to the processing command from the company information 131, the transaction history 132, and the transaction relationship information 133 stored in the storage unit 130 (S1001).

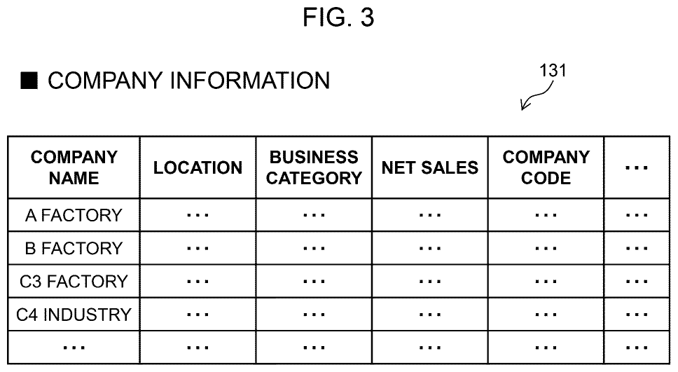

FIG. 3 is a diagram showing an example of the company information 131.

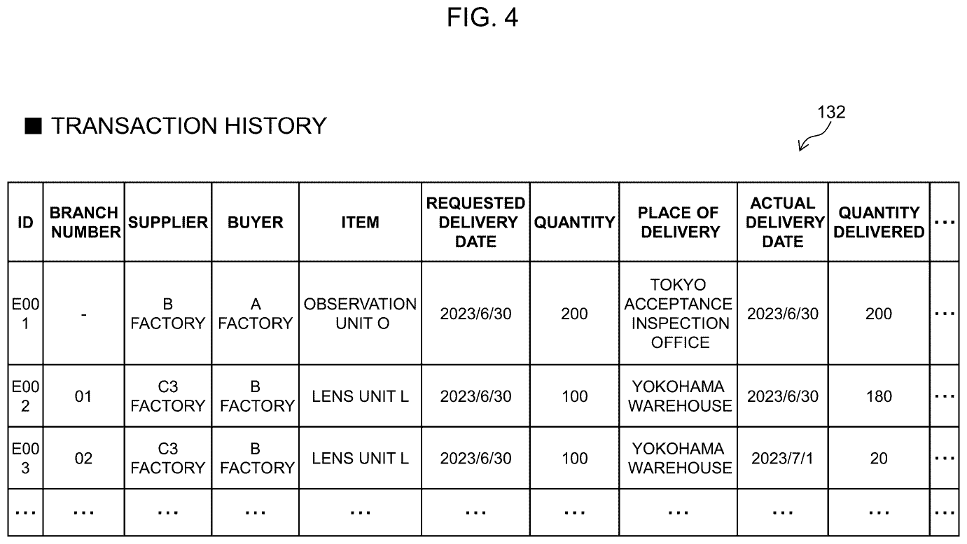

FIG. 4 is a diagram showing an example of the transaction history 132.

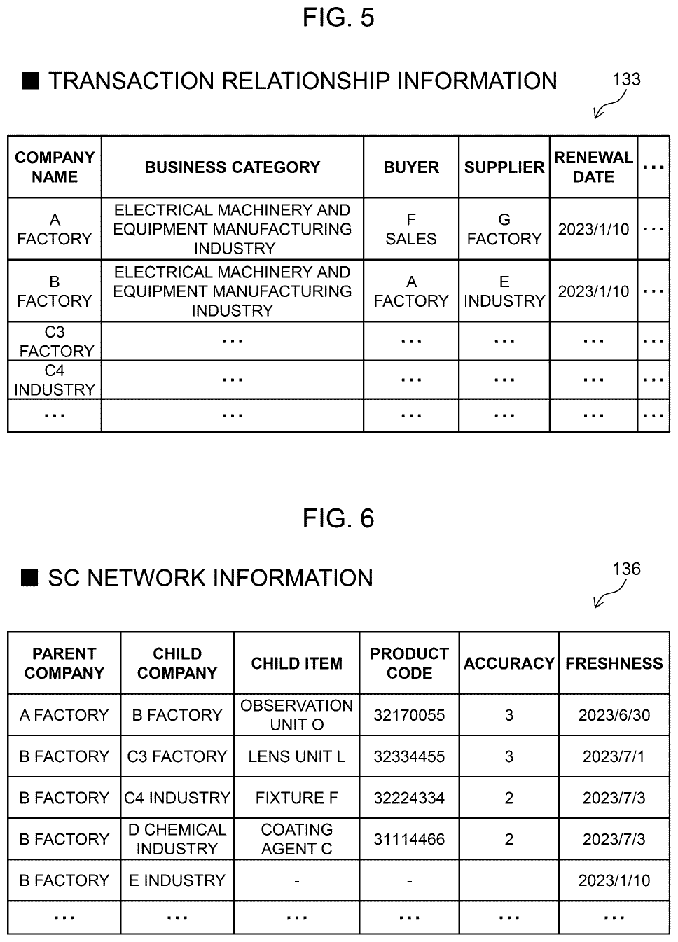

FIG. 5 is a diagram showing an example of the transaction relationship information 133. As shown in FIG. 3, the company information 131 includes information concerning the company name, location, business category, net sales, and company code of each company.

As shown in FIG. 4, the transaction history 132 includes information such as the ID, branch number, supplier's company name, buyer's company name, items handled, requested delivery date, quantity, place of delivery, actual delivery date, and quantity delivered. The transaction history 132 is accumulated in transactions between companies such as e-commerce services. Note that the term “companies” as used in this embodiment do not necessarily have to be based on a separate capital, and even when different business divisions are included in the same company, each business division may be deemed a company and use the apparatus and method of the present invention. Moreover, in addition to the examples shown in FIG. 3, the company information 131 may also include information required for producing and distributing items, such as the location of the business establishment and the items that are being produced.

As shown in FIG. 5, the transaction relationship information 133 registers the company name, business category, list of buyer companies, list of supplier companies, and renewal date of each company. In this embodiment, it is assumed that the transaction relationship information 133 will be provided in company information services and the like. If the provider of the transaction history 132 and the provider of the transaction relationship information 133 are different, the same company may be defined by different character strings due to variations in the notation. Moreover, the suppliers and the buyers in the transaction history 132 may be managed by company codes rather than by company names. In such a case, by linking the company names and the company codes in the company information 131 of FIG. 3 and mutually referencing the company codes, it is possible to determine that they are the same company.

Returning to FIG. 2, in S1002, the supply chain network creation unit 121 creates a supply chain network using the transaction history 132 and the transaction relationship information 133 read in S1001. S1002 includes the processing from the transaction relationship extraction of S1003 to the resetting of the parent company and the parent item of S1008. The supply chain network creation unit 121 performs these types of processing by tracing the supply chain upstream in order from the main company (also referred to as a parent company or a target company) and item (also referred to as a parent item or a target item) for which the supply chain network is to be created, and then proceeds to the SC display/correction acceptance step of S1009. Specifically, by foremost performing the processing of S1003 to S1008 with the main company (also referred to as a parent company or a target company) and item (also referred to as a parent item or a target item) for which the supply chain network is to be created as the parent company and the parent item, the item used in the production of the parent item (hereinafter referred to as the “child item”) and the company handling such item (hereinafter referred to as the “child company”) are identified. Subsequently, the processing of S1003 to S1008 is additionally performed for the child company and the child item to identify the grandchild company and the grandchild item. Accordingly, in S1002, the processing is repeated to the target item for which the supply chain network is created by tracing the supply chain upstream to identify the child item, grandchild item . . . until the child item of the target item can no longer be identified.

The process of identifying the child company and the child item from the parent company and the parent item based on each of the steps S1003 to S1008 is now explained.

In S1003, the supply chain network creation unit 121 extracts the supplier companies of the parent company among the companies doing business with the parent company. Specifically, the supply chain network creation unit 121 extracts the supplier, item, and delivery date of the record in which the buyer is the parent company from the transaction history 132 shown in FIG. 4. Here, if there are multiple pieces of information of the same supplier and item, the one with the most recent delivery date is extracted. Next, the supply chain network creation unit 121 extracts the records whose company name is the parent company from the transaction relationship information 133 of FIG. 5, and acquires the supplier and the renewal date. In addition, the supply chain network creation unit 121 extracts the company name and the renewal date of the records in which the parent company is included in the buyer of the transaction relationship information 133 of FIG. 5. The supply chain network creation unit 121 additionally integrates these lists to create a supplier company list of the parent company, and stores the created supplier company list in the SC network information 136 stored in the storage unit 130.

FIG. 6 is a diagram showing an example of the SC network information 136.

As shown in FIG. 6, the SC network information 136 stores information of parent companies, child companies, child items, product codes of child items, and accuracy and freshness of the network. Each company and item in the supplier company list is registered as a child company and a child item for a parent company. Note that, for the child company created from the transaction relationship information 133 of FIG. 5, there will be no information of the child items because the items being traded cannot be identified. The accuracy of the network will be explained in the BOM creation processing of S1006 described later. For the freshness of the network, the delivery date information of the transaction history 132 or the renewal date of the transaction relationship information 133 is stored.

In the foregoing case, it could be said that the supply chain network creation unit 121 creates the SC network information 136 representing the relationship of the order-placing company (parent company in FIG. 6), the order-accepting company (child company in FIG. 6), and the item handled by the order-accepting company (child item in FIG. 6) based on the transaction history 132. Moreover, it could be said that the supply chain network creation unit 121 creates the SC network information 136 by further adding the transaction relationship information 133 (see FIG. 5) including the buyer companies and the supplier companies.

Returning to FIG. 2, in S1004, the supply chain network creation unit 121 refers to the company item information 137 and determines whether there is any BOM information 135.

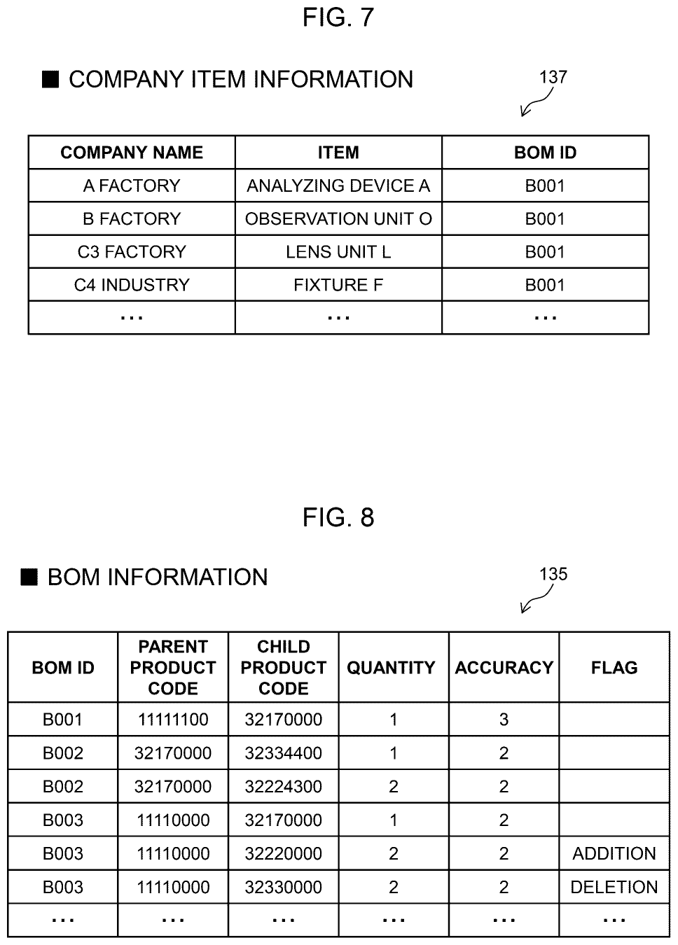

FIG. 7 is a diagram showing an example of the company item information 137.

As shown in FIG. 7, the company item information 137 registers a BOM ID, which indicates the BOM information 135 used for each company and item. The BOM ID is acquired by searching for the company name and the item name of the company item information 137 with the parent company and the parent item to be processed as the keys. Here, if a BOM ID could not be acquired, the supply chain network creation unit 121 determines that there is no BOM information 135, and then proceeds to S1006. Meanwhile, when a BOM ID is acquired, the supply chain network creation unit 121 reads the BOM information 135 in S1005.

FIG. 8 is a diagram showing an example of the BOM information 135.

As shown in FIG. 8, the BOM information 135 registers the parent-child relationship of items, including the parent product code, a small product code as a component of the parent product code, and the quantity, accuracy, and flag per unit of the parent product. The accuracy and the flag usage will be explained in the processing described later. In S1006, the BOM creation unit 122 executes the processing of BOM creation. The BOM creation processing is now explained in detail.

### <BOM Creation>

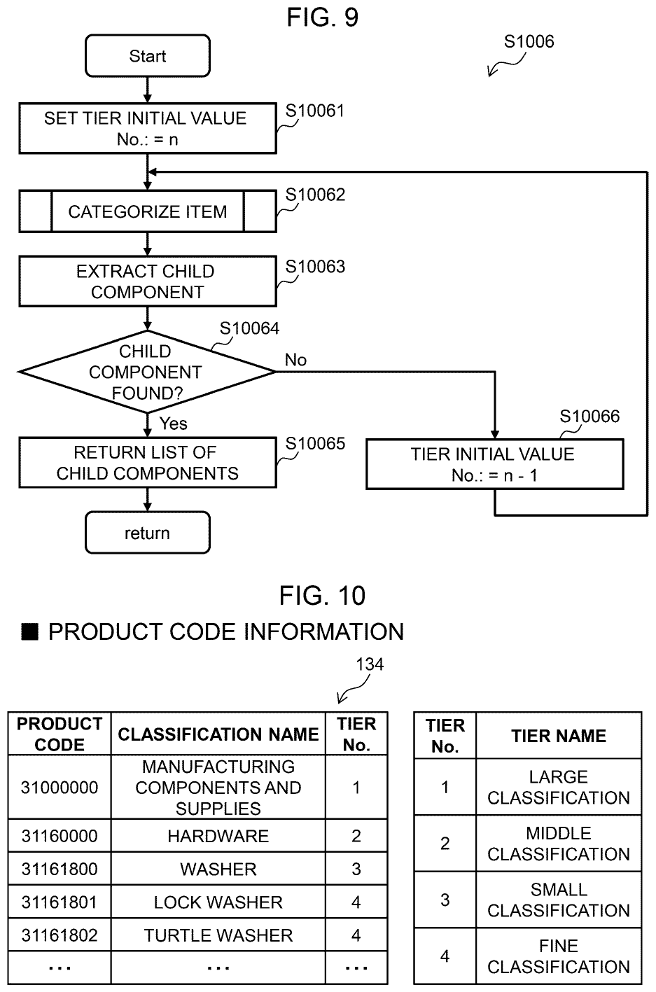

FIG. 9 is a flowchart showing the operational flow when the BOM creation unit 122 creates a BOM.

The supply chain network creation apparatus 100 in this embodiment starts the BOM creation processing upon detecting a processing command from the supply chain network creation unit 121. Here, the supply chain network creation unit 121 receives the company and the item for which a BOM is to be created, and also receives a BOM ID if there is any BOM information 135.

In S10061, the BOM creation unit 122 reads the product code information 134 stored in the storage unit 130, and sets the tier initial value number of the product code information 134.

FIG. 10 is a diagram showing an example of the product code information 134. The product code information 134 is information in which the items are classified. The product code information 134 is an example of the item classification table in which items are defined in two or more classification tiers, and registers the product code, classification name, and tier number. In this embodiment, an example will be described in which the internationally used product classification code: UNSPSC (United Nations Standard Products and Services Code) is used as the product code information 134. UNSPSC is a tiered classification system in which items are classified into large classification, middle classification, small classification, and fine classification with serial numbers of two digits in order starting from the first two digits of the product code. For example, a turtle washer has a product code of 31161801. In the foregoing case, a turtle washer is classified as 31 “manufacturing components and supplies” in the large classification, and classified as 3116 “hardware” in the middle classification. Moreover, a turtle washer is classified as 311618 “metal washer” in the small classification, and classified as 31161802 “turtle washer” in the fine classification.

The BOM creation unit 122 refers to the product code and assigns a tier number to the classification name. For example, because washers are defined up to the small classification, the tier number is 3. Note that the product code information 134 may be a code system other than UNSPSC so as long as the items are classified based on a tiered classification system.

Returning to the explanation of the processing of S10061, the BOM creation unit 122 sets a number that is one minus the maximum value of the tier number as the initial value n. In the example of FIG. 10, there are four tiers, and the tier number will be one among 1 to 4, and the maximum value is 4. Therefore, the BOM creation unit 122 sets 3, which is obtained by subtracting one from the maximum value 4, as the initial value n (n=3), and then proceeds to the next processing.

In S10062, the item categorization processing is performed. Specifically, the target tier number and the item name are delivered to the item categorization unit 123, and a product code to become the category of the item is acquired from the return value from the item categorization unit 123. The item categorization processing performed by the item categorization unit 123 is now explained in detail.

In this processing, the item categorization unit 123 identifies the category in which the tier number to which the parent item belongs is n by comparing the classification name having the tier number of n+1 and the item name of the parent item, and thereby calculates the similarity. Various methods have been proposed for calculating the similarity between texts such as the classification name and the item name, including the Levenshtein distance and the Jaro-Winkler distance, and this embodiment does not limit the method that may be used. Note that, for simplifying this embodiment, the processing is explained by defining the similarity as the ratio of the character string of the item name of the parent item included in the classification name. For example, if the item name of the parent item is “metal washer A”, the character string of these three terms and the classification name belonging to the fine classification of tier number 4 are compared. Here, the similarity with “rokku wossha (in katakana; “lock washer” in English)” in FIG. 10 will be 0/3=0, and the similarity with “turtle metal washer” will be 2/3. In this way, the similarity between the parent item and all classification names belonging to the tier number n+1 is calculated.

Next, the item categorization unit 123 calculates the average value of the calculated similarities for each tier number n, and sets the product code with the highest average value as the category when the tier number of the parent item is n. In the previous example of “metal washer A”, if the product code with the highest average value is 31161800 “metal washer”, the category in tier number 3 of “metal washer A” will be “metal washer” with the product code 31161800.

Here, it could also be said that the item categorization unit 123 calculates the similarity between the item name of the first tier (in the foregoing case, tier number 4), which is the finest tier in the product code information 134, and the item being traded, and classifies the item being traded to the item name of the second tier (in the foregoing case, tier number 3), which is a tier one level above the first tier, and which includes the greatest number of similar item names of the first tier.

Returning to the explanation of the BOM creation unit 122 of FIG. 9, in S10063, the BOM creation unit 122 extracts a supplier group that handles the items in the same category as the category acquired in S10062 from the transaction history 132, and identifies the items that are being commonly procured by each supplier as the buyer. Specifically, foremost, the BOM creation unit 122 performs item categorization to the character strings registered in the items of the transaction history 132, and determines the category of each item when the tier number is n.

Next, the BOM creation unit 122 extracts the suppliers from the transaction history 132 of the same category as the category of the parent item.

Next, the BOM creation unit 122 refers to the buyer column of the transaction history 132, and extracts, for each supplier, the category of the items procured by the supplier from the transaction history 132 in which the supplier is registered as the buyer.

Next, the BOM creation unit 122 deems the category being commonly procured by each supplier as the child component of the parent item. Finally, if there is a BOM ID, the child product code and the child component of the corresponding BOM information 135 are compared, and the child component is added if it is not included in the BOM information 135, and “addition” is registered in the flag. If there is no BOM ID, a new BOM ID is numbered, and all child components are added to the BOM information 135 as flag “addition”.

In the foregoing case, it could also be said that the BOM creation unit 122 creates a bill of materials based on the items according to the classification estimated by the item categorization unit 123. If each supplier is using the same item, the child component can be identified based on this item. Nevertheless, in effect, each supplier may call the same item using a different name. In other words, the notation varies from supplier to supplier. For example, even if it is the same washer, a certain supplier may refer to this item as “metal washer A”, and another supplier may refer to this item as “∘∘ washer”. Even in the foregoing case, as a result of the item categorization unit 123 performing item categorization and extracting the category, the item can be given the same name. In the foregoing case, whether the name is “metal washer A” or “∘∘ washer”, the category will be “metal washer”, and they can be deemed to be the same item as a child component. Accordingly, the child component can be identified easily, and a highly accurate supply chain network can be created.

In S10064, the BOM creation unit 122 performs the determination processing of determining whether one or more child components have been found in S10063.

As a result, if one or more child components are found (Yes in S10063), the BOM creation unit 122 proceeds to S10065, and returns the information of the child components as a return value to the supply chain network creation unit 121. If no child component has been found (No in S10063), the BOM creation unit 122 proceeds to S10066, and returns to the processing of S10062 upon raising the tier for processing the item categorization by one tier (n: =n−1).

A pair of the parent component and the child component created by the BOM creation unit 122 is more specific when it is identified by the fine classification; that is, a classification with a higher tier number. In the foregoing example of “metal washer A”, it is evident that “metal washer” of the small classification is more specific than “hardware” of the middle classification. Nevertheless, as described above, the item names registered in the transaction history 132 are often indicated differently depending on the company or the person in charge of ordering, and when the category is identified by limiting it to a specific tier, the similarity will deteriorate and it may not be possible to find the child component. In this embodiment, emphasis is placed on creating some kind of answer even if the accuracy is somewhat low, and the processing is such that the tier is moved up until the child component is found. The tier when the BOM was created is registered in “accuracy” of the BOM information 135, and used in the SC display/correction acceptance processing of S1009 described later. In the foregoing case, it could also be said that, when there is no item that is similar to the first tier (in the foregoing case, tier number 4), the item categorization unit 123 classifies the item being traded by sequentially increasing the tier. In effect, the tier is increased in order of tier number 3, tier number 2, and so on.

Returning to the explanation of the supply chain network creation unit 121 of FIG. 2, in S1007, the supply chain network creation unit 121 performs the processing of narrowing down the transaction relationship.

As the processing of narrowing down the transaction relationship, the supply chain network creation unit 121 searches for a record in which the child component output in S1006 is registered from the SC network information 136 indicating the transaction relationship of the parent company created in S1003, and registers “accuracy”, which is registered in the BOM information 135, in the “accuracy” column. Next, the record of companies and items other than the child component output in S1006 is deleted. By performing this deletion, only the records related to the parent item will remain. In other words, while the supply chain network creation unit 121 creates a supply chain network based on the SC network information 136, here, it creates a supply chain network by deleting the companies that are not included in the BOM. To put it differently, while the supply chain network creation unit 121 can create a general supply chain network based on the SC network information 136, there are cases where items, which are unrelated to the parent item, are also included. The supply chain network creation unit 121 creates a supply chain network by using a BOM and eliminating items that are unrelated to the parent item. It is thereby possible to create a highly accurate supply chain network for the parent item.

In S1008, the supply chain network creation unit 121 resets the parent company and the parent item. The resetting of the parent company and the parent item is the processing of selecting the company and the item to subsequently undergo the processing of S1003 to S1008, and then resetting them as the parent company and the parent item. As the parent company and the parent item to subsequently undergo the processing, selected is the item of the same tier of the BOM as the company and the item that were used as the parent company and the parent item, or the company and the item that are one tier lower if the processing of the item of that tier has been completed. The loop of S1002 is executed until there is no longer any parent company and parent item to subsequently undergo the processing, and the supply chain network creation unit 121 proceeds to the SC display/correction acceptance processing of S1009. In the foregoing case, it could be said that the supply chain network creation unit 121 is creating a supply chain network by deleting the companies that are not included in the BOM for each tier when considering the tier relationship of the order-placing company and the order-accepting company. When narrowing down the companies after estimating the company item network of all products from the parent company, the time and memory required for extracting the companies connected to the companies to be deleted will be wasted. By performing processing for each tier, the time and memory required for this company group extraction processing can be conserved. In the foregoing case, it could also be said that the supply chain network creation unit 121 is attempting to reduce the resources used to create a supply chain network.

In S1009, the supply chain network creation unit 121 performs SC display/correction acceptance. The SC display/correction acceptance is the processing of displaying the supply chain network created based on the processing of S1002 to S1008 on a screen, and accepting a correction input from the user.

### <Display of Supply Chain Network>

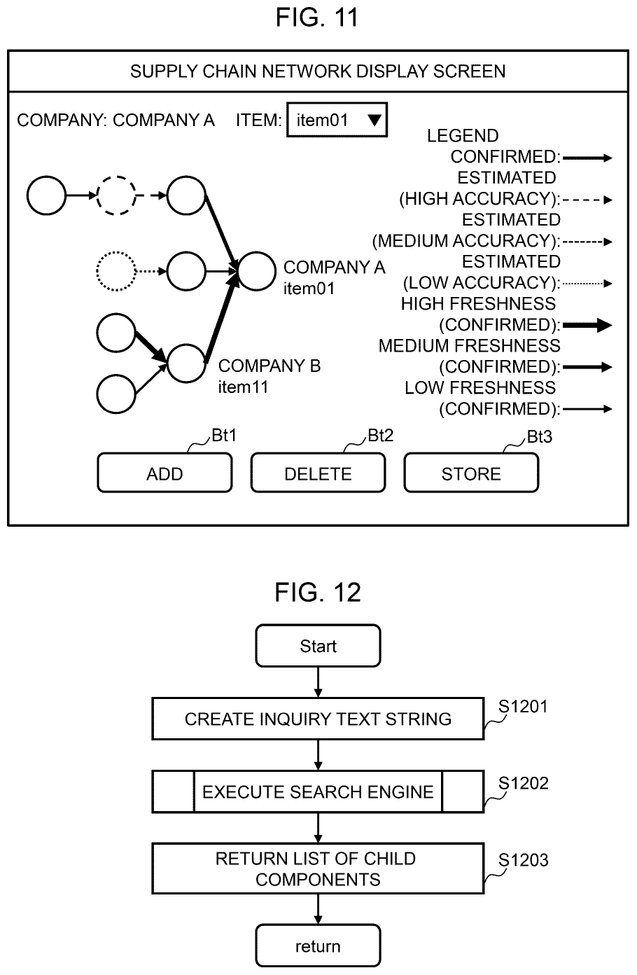

FIG. 11 is a diagram showing an example of the display screen of the supply chain network.

In the illustrated screen example, the company and the time for which a supply chain network is to be created are displayed at the upper part of the screen. In FIG. 11, shown is a supply chain network of a case where the company is company A and the item is item 01.

In a supply chain network, companies and items are represented as nodes and transaction relationships as arcs, and one node is represented as a circle and one arc is represented as an arrow connecting the nodes. A company name and/or an item name corresponding to the node is displayed near that node.

The display of the circle of the node and the arrow of the arc is changed depending on the accuracy and/or the freshness of the supply chain network. The freshness of the supply chain network is calculated based on the period from the date stored in the freshness of the SC network information 136 shown in FIG. 6 to the time that this processing is executed. In the example of FIG. 11, as shown in the legend at the upper right corner, the freshness is classified into the three levels of high, medium and low. For example, the freshness is classified as high when the period is within 90 days, medium when the period is 91 days to 365 days, and low when the period is 366 days or longer. It can also be said that the freshness represents the reliability of whether or not there is a transaction relationship. In other words, the freshness is higher as the date is newer, and it can be considered that the possibility of having a transaction relationship is high even as at the present moment.

Moreover, in the example of FIG. 11, as another example of a method of changing the display, the accuracy of the SC network information 136 is referenced, and, as with the freshness, classified into the three levels of high, medium and low. In FIG. 11, a solid line is used when it is confirmed that there is a transaction relationship, a broken line is used when it is estimated that there is a transaction relationship and the accuracy thereof is high, a dotted like is used when it is estimated that there is a transaction relationship and the accuracy thereof is low, and at the same time the thickness of the line is used to express the freshness. The term “accuracy” used in this embodiment when it is estimated that there is a transaction relationship is the tier number of the item categorization as described above. It can also be said that “accuracy” represents the reliability of whether or not there is a transaction relationship. By deeming that the accuracy is higher as the tier number is larger, 3 can be classified as high, 2 can be classified as medium, and 1 can be classified as slow. As a means for changing the display of the accuracy or the freshness, in addition to the method of using a solid line and a broken line and a dotted line and the method of changing the thickness of the lines, considered may be a method of using different colors or a method of causing the lines to flash and expressing the accuracy or freshness based on differences in the flashing interval, but the method is not limited to these methods.

In the foregoing case, it could also be said that the supply chain network creation unit 121 creates display information representing a supply chain network with the order-placing company as the parent node, the order-accepting company as the child node, and the transaction relationship as the arc. Moreover, it could also be said that the supply chain network creation unit 121 creates display information by changing the method of displaying at least one of either the arc or the node depending on at least one of either the accuracy of the transaction relationship or the newness at the time that the transaction history 132 was created (in the foregoing case, freshness).

Arranged on the screen are an add button Bt1 to call a function for adding a node or an arc to the supply chain network, a delete button Bt2 to call a function for deleting a node or an arc from the supply chain network, and a store button Bt3 to call a function for storing the displayed SC network information 136. The user can determine whether the displayed SC network information 136 is correct or incorrect, and correct the node and/or the arc by using the addition function and the deletion function as needed. When the storage function is called by the user after the supply chain network is corrected, the supply chain network creation unit 121 proceeds to the BOM information storage of S1010.

In S1010, the supply chain network creation unit 121 stores the BOM information. The BOM information storage is the processing of storing the SC network information 136, which was corrected by the user in S1009, in the BOM information 135 included in the storage unit 130 as the BOM information of the item for which a supply chain network is to be created. Here, taking into consideration the possibility that the BOM may differ depending on the company or product specification even for the same item, the BOM is assigned an ID that does not overlap with existing BOMs and then stored.

The second embodiment is now explained.

### Second Embodiment

In the second embodiment, the BOM creation unit 122 in the supply chain network creation apparatus 100 creates a BOM using generative AI (Artificial Intelligence) or a search engine.

FIG. 12 is a flowchart showing the method of creating a BOM in the second embodiment. First, the BOM creation unit 122 creates one or more patterns of character strings inquiring about materials to be used for producing the target item. As the character string patterns, at least one or more character strings are created by additionally combining a character string each including “component” with (1) item name, (2) word combination in which the item name is divided by a delimiter such as a space using morphological analysis or other means, and (3) combination of the company's industrial classification and item name (S1201). For example, when creating a BOM in which the item name is “analyzing device A”, the character string in a case of using a search engine with “,” as the delimiting character may be (1) “analyzing device A, component”; (2) “analyzing device, A, component” and (3) “semiconductor manufacturing, analyzing device A, component”, and the character string in a case of generative AI may be (1) “Please tell me the components of analyzing device A”; (2) “Please tell me the components of the analyzing device” and (3) “Please tell me the components of the analyzing device A in the semiconductor manufacturing business”. Next, the BOM creation unit 122 inputs the created character string in generative AI or a search engine via the communication unit 140 as needed (S1202), extracts the item name to become the component from the character string of the output result, and then returns it as the child component (S1203).

In the foregoing case, the BOM creation unit 122 creates a character string inquiring about materials to be used in producing the item, and creates the BOM using generative AI or a search engine based on the character string.

The processing of the second embodiment can be substituted for the BOM creation unit 122 of the first embodiment, or called in the processing of S10066 of FIG. 9 when the tier number becomes 0, whereby the result is used in S10065.

### Hardware Configuration

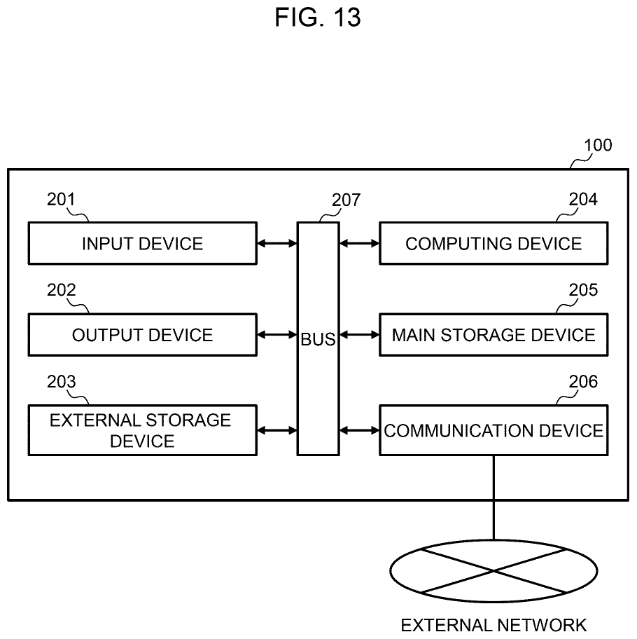

FIG. 13 is a diagram showing a hardware configuration example of the supply chain network creation apparatus 100 in this embodiment.

In this embodiment, the supply chain network creation apparatus 100 is, for example, an information processing device such as a personal computer (PC), a workstation, or a server device, but is not limited thereto, and may also be an electronic information terminal such as a smartphone, a portable phone terminal or a PDA (Personal Digital Assistant).

In other words, the supply chain network creation apparatus 100 is configured by including an input device 201, an output device 202, an external storage device 203, a computing device 204, a main storage device 205, a communication device 206, and a bus 207 that mutually connects these devices.

The input device 201 is a device that receives inputs from, for example, a keyboard, mouse, a touch pen, or other pointing devices.

The output device 202 is a device such as a display that displays information.

The external storage device 203 is, for example, a hard disk device or a non-volatile storage device such as a flash memory.

The computing device 204 is, for example, a computing means such as a CPU.

The main storage device 205 is, for example, a memory device such as a RAM (Random Access Memory).

The communication device 206 is a wireless communication device that performs wireless communication via an antenna, or a wired communication device that performs wired communication via a network cable.

The storage unit 130 of the supply chain network creation apparatus 100 is realized by the main storage device 205 of the supply chain network creation apparatus 100 or the external storage device 203.

Moreover, the input unit 110, the computing unit 120, and the output unit 150 of the supply chain network creation apparatus 100 are realized by programs that cause the computing device 204 of the supply chain network creation apparatus 100 to perform processing.

These programs are stored in the main storage device 205 or the external storage device 203, and loaded in the main storage device 205 for execution, and then executed by the computing device 20. Moreover, the supply chain network creation apparatus 100 may also include a communication device 206 as needed, and send and receive information via the communication device 206.

According to the embodiment described above in detail, it is possible to provide a supply chain network creation apparatus 100 that, when creating a supply chain network for a target item, can extract companies up to the upstream and is less likely to include companies that are not related to the item.

### <Explanation of Supply Chain Network Creation Method>

As described above, the processing performed by the supply chain network creation apparatus 100 can be realized through the coordination of software and hardware resources.

Therefore, the processing performed by the supply chain network creation apparatus 100 described above can be considered to be a supply chain network creation method in which a processor such as the computing device 204 executes a program recorded in a memory such as the main storage device 205 and thereby creates a BOM based on the transaction history information 132 including information on an order-placing company, an order-accepting company, and items traded between the order-placing company and the order-accepting company, and creates a supply chain network representing a transaction relationship between the order-placing company and the order-accepting company based on the BOM.

Moreover, a program that runs on the supply chain network creation apparatus 100 can be considered to be a program for realizing a function of creating a BOM based on the transaction history 132 including information on an order-placing company, an order-accepting company, and items traded between the order-placing company and the order-accepting company, and a function of creating a supply chain network representing a transaction relationship between the order-placing company and the order-accepting company based on the BOM.

Note that the program for realizing this embodiment can of course be provided using a communication means, but can also be provided by being stored in a recording medium such as a CD-ROM.

While this embodiment has been explained above, the technical scope of the present invention is not limited to the scope described in the foregoing embodiment. It is obvious from the wording of the claims that the various modifications and improvements to the foregoing embodiment are also covered by the technical scope of the present invention.

### REFERENCE SIGNS LIST

1 . . . information processing system, 100 . . . supply chain network creation apparatus, 110 . . . input unit, 120 . . . computing unit, 121 . . . supply chain network creation unit, 122 . . . BOM creation unit, 123 . . . item categorization unit, 130 . . . storage unit, 131 . . . company information, 132 . . . transaction history, 133 . . . transaction relationship information, 134 . . . product code information, 135. . . . BOM information, 136. . . . SC network information, 137 . . . company item information, 140 . . . communication unit, 150 . . . output unit, 160 . . . display unit

1. A supply chain network creation apparatus, comprising:
a bill of materials creation unit that creates a bill of materials based on a transaction history including information on an order-placing company, an order-accepting company, and items traded between the order-placing company and the order-accepting company; and
a supply chain network creation unit that creates a supply chain network representing a transaction relationship between the order-placing company and the order-accepting company based on the bill of materials.

2. The supply chain network creation apparatus according to claim 1,
wherein the bill of materials creation unit creates the bill of materials for items procured commonly by the order-placing company from the order-accepting company based on the transaction history.

3. The supply chain network creation apparatus according to claim 2, further comprising:
an item categorization unit that, based on an item classification table in which items are defined in two or more classification tiers, estimates tiers in the item classification table and classifications for each tier for items being traded from the transaction history, wherein the bill of materials creation unit creates the bill of materials based on classification items estimated by the item categorization unit.

4. The supply chain network creation apparatus according to claim 3,
wherein the item categorization unit determines a similarity between an item name of a first tier, which is a most detailed tier in the item classification table, and an item being traded, and classifies the item being traded under an item name of a second tier, which contains a largest number of similar items of the first tier and which is one level above the first tier.

5. The supply chain network creation apparatus according to claim 4,
wherein the item categorization unit, when there is no item that is similar to the first tier, classifies the item being traded by successively increasing the tier.

6. The supply chain network creation apparatus according to claim 1,
wherein the supply chain network creation unit creates supply chain network information representing a relationship among the order-placing company, the order-accepting company, and the items handled by the order-accepting company based on the transaction history, and creates the supply chain network based on the supply chain network information.

7. The supply chain network creation apparatus according to claim 6,
wherein the supply chain network creation unit creates the supply chain network information in addition to transaction relationship information including buyer companies and supplier companies.

8. The supply chain network creation apparatus according to claim 1,
wherein the supply chain network creation unit creates the supply chain network by deleting companies not included in the bill of materials.

9. The supply chain network creation apparatus according to claim 8,
wherein the supply chain network creation unit creates the supply chain network by deleting companies not included in the bill of materials for each tier when considering the tier relationship of the order-placing company and the order-accepting company.

10. The supply chain network creation apparatus according to claim 1,
wherein the supply chain network creation unit creates display information representing a supply chain network in which the order-placing company is a parent node, the order-accepting company is a child node, and the transaction relationship is an arc.

11. The supply chain network creation apparatus according to claim 10,
wherein the supply chain network creation unit creates the display information by changing a method of displaying at least one of either the arc or the node depending on at least one of either accuracy of the transaction relationship or newness at a time when the transaction history was created.

12. The supply chain network creation apparatus according to claim 1,
wherein the bill of materials creation unit creates a character string inquiring about materials to be used in producing the item, and creates the bill of materials using generative AI or a search engine based on the character string.

13. A supply chain network creation method,
wherein a processor executes a program recorded in a memory to:
create a bill of materials based on a transaction history including information on an order-placing company, an order-accepting company, and items traded between the order-placing company and the order-accepting company; and
create a supply chain network representing a transaction relationship between the order-placing company and the order-accepting company based on the bill of materials.

14. A program that causes a computer to realize:
a function of creating a bill of materials based on a transaction history including information on an order-placing company, an order-accepting company, and items traded between the order-placing company and the order-accepting company; and
a function of creating a supply chain network representing a transaction relationship between the order-placing company and the order-accepting company based on the bill of materials.
